(19) United States
(12) Patent Application Publication
(10) Pub. No.: US 2025/0153927 A1
(43) Pub. Date: May 15, 2025

(54) PRESSURIZED OIL SPRAY BOTTLE STRUCTURE

(71) Applicant: Shenzhen Yuyu Bupian'an Creative Design Co., Ltd., Shenzhen (CN)

(72) Inventor: Wenjue Lin, Shenzhen (CN)

(21) Appl. No.: 19/019,793

(22) Filed: Jan. 14, 2025

(51) Int. Cl. B65D 83/206; B65D 83/141; B65D 83/28; B65D 83/48

(52) U.S. Cl. CPC B65D 83/206; B65D 83/141; B65D 83/28; B65D 83/48

(57) ABSTRACT

A pressurized oil spray bottle structure is provided and relates to the technical field of pressurized oil spray bottles. The pressurized oil spray bottle includes a housing; a piston chamber is in the housing; a piston main body is slidably arranged in the piston chamber; a double-torque spring is on one side of an inner upper end of the housing; a trigger is arranged on one side, away from the double-torque spring, in an upper end of the housing; a sealing valve body is mounted on the top inside the housing; a sealing valve spring is arranged in the sealing valve body; a nozzle is on one side of the sealing valve body; and an oil receiving box is mounted on the bottom of the nozzle. The oil receiving box is arranged to store residual oil for easy cleaning.

### TECHNICAL FIELD

The present disclosure relates to the technical field of pressurized oil spray bottles, and in particular, to a pressurized oil spray bottle structure.

### BACKGROUND

Oil spray bottles are attracting more and more attentions of health-conscious people due to their advantages of convenience, precise oil volume, cleanliness, and hygiene. A pressurization chamber, a piston, a trigger structure, and a nozzle in the oil spray bottle play a very important role as key components of the oil spray bottle. With improved living standards and the prevalence of unhealthy habits, cardiovascular diseases, obesity, and fatty liver have become increasingly common. Reducing oil consumption has become a priority for many health-conscious individuals.

In the prior art, the trigger structure of the existing oil spray bottle has a complex mold and is prone to aging after long-time use, which results in a decrease in a rebound force. Residual oil is easily left at an opening of the nozzle of the existing oil spray bottle, and the residual oil easily flows onto the trigger, which is unhygienic and affects use. Therefore, those skilled in the art have provided a pressurized oil spray bottle structure to solve the problems in the background section.

### SUMMARY

The present disclosure aims to solve the shortcomings in the prior art, and provides a pressurized oil spray bottle. During use of the device, through a double-torque spring and an oil receiving box, this structure ensures the trigger maintains consistent rebound force over extended use, preventing residual oil from dripping onto the trigger and instead channeling it into an oil groove.

To achieve the above objectives, the present disclosure provides the following technical solution: A pressurized oil spray bottle structure includes a housing; a piston chamber is in the housing; a piston main body is slidably arranged in the piston chamber; a double-torque spring is on one side of an inner upper end of the housing; a trigger is arranged on one side, away from the double-torque spring, in an upper end of the housing; a sealing valve body is at the inner upper end of the housing; a sealing valve spring is arranged in the sealing valve body; a nozzle is mounted on one side of the sealing valve body; and an oil receiving box is mounted on the bottom of the nozzle.

Further, an oil storage bottle is sleeved in a lower end of the housing through a thread, and an air inlet hole is fixedly provided in one side inside the housing.

Further, a straw is mounted on the bottom inside the housing, and a foreign matter filter plate is mounted on the bottom of the straw.

Further, a first channel and a second channel are mounted on the bottom of the piston chamber, and a pre-atomization chamber and a pre-atomization channel are on one side inside the housing.

Further, the pre-atomization chamber is connected to the second channel and the pre-atomization channel, and the pre-atomization channel is connected to the nozzle.

Further, a pressure chamber is mounted on the bottom inside the housing; a pressure valve bottom plug is mounted on the bottom inside the pressure chamber; and a pressure valve spring plug is mounted on the top of the pressure valve bottom plug.

Further, a pressure valve piston spring is mounted on the top of the pressure valve spring plug; and a pressure valve piston body is mounted on the top of the pressure valve piston spring.

Further, a pressure valve piston push rod is arranged on the bottom of the pressure valve piston body, and the pressure valve piston push rod is slidably arranged inside the pressure valve piston spring.

The present disclosure has the following beneficial effects:

According to the pressurized oil spray bottle provided by the present disclosure, during use of the device, by the arrangement of the double-torque spring and the oil receiving box, the double-torque spring provides a sufficient elastic force to make the trigger move more quickly, so that the spraying time is shortened. If the trigger is used for a long time, the trigger is prone to aging, which results in a decrease in a rebound force. Residues are reduced. In addition, by the arrangement of the oil receiving box, residual oil at the nozzle does not flow onto the trigger, but flows into an oil groove through a dedicated channel, to store the residual oil. It is convenient for cleaning.

### BRIEF DESCRIPTION OF THE DRAWINGS

FIG. 1 is a schematic axonometric diagram of the present disclosure;

FIG. 2 is a schematic axonometric diagram of a housing according to the present disclosure; and

FIG. 3 is a cross-sectional view of the present disclosure.

### REFERENCE NUMERALS

1: nozzle; 2: trigger; 3: housing; 4: oil storage bottle; 5: air inlet hole; 6: pressure valve piston spring; 7: straw; 8: foreign matter filter plate; 9: sealing valve body; 10: oil receiving box; 11: pre-atomization channel; 12: pre-atomization chamber; 13: pressure valve piston body; 14: pressure valve piston push rod; 15: sealing valve spring; 16: double-torque spring; 17: piston main body; 18: piston chamber; 19: first channel; 20: second channel; 21: pressure chamber; 22: pressure valve spring plug; and 23: pressure valve bottom plug.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

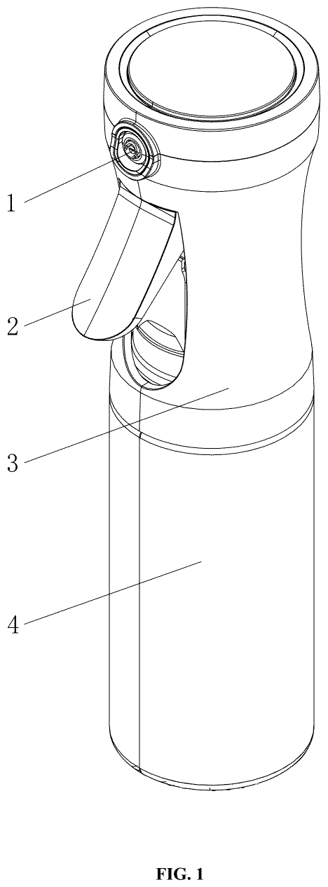

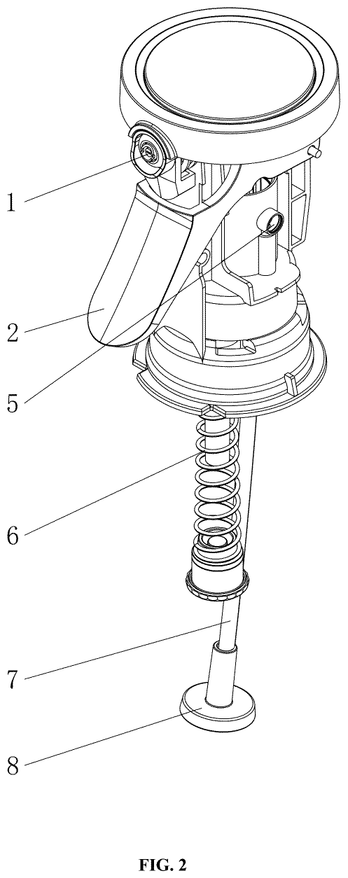

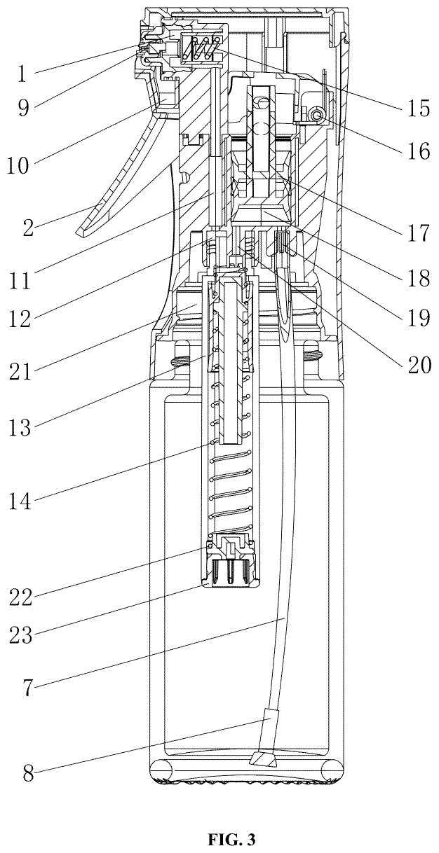

Referring to FIG. 1, FIG. 2, and FIG. 3, the present disclosure provides an embodiment: A pressurized oil spray bottle structure includes a housing 3. A piston chamber 18 is in the housing 3. A piston main body 17 is slidably arranged in the piston chamber 18. A double-torque spring 16 is on one side of an inner upper end of the housing 3. A trigger 2 is arranged on one side, away from the double-torque spring 16, in an upper end of the housing 3. A sealing valve body 9 is mounted on the top inside the housing 3. A sealing valve spring 15 is arranged in the sealing valve body 9. A nozzle 1 is on one side of the sealing valve body 9. An oil receiving box 10 is mounted on the bottom of the nozzle 1. An oil storage bottle 4 is sleeved in a lower end of the housing 3 through a thread, and an air inlet hole 5 is fixedly provided in one side inside the housing 3. A straw 7 is mounted on the bottom inside of the housing 3, and a foreign matter filter plate 8 is mounted on the bottom of the straw 7.

Specifically, during use of the device, the trigger 2 is pressed, so that cooking oil can be sprayed out from the nozzle 1. After the nozzle 1 sprays the cooking oil, residual cooking oil at an outlet part of the nozzle 1 may flow through a dedicated channel into the oil receiving box 10 at the lower end of the nozzle 1, which is beneficial to: prevent the residual cooking oil from flowing to the trigger 2, avoid the trigger 2 from being contaminated, and avoid the impact on the normal use of the trigger 2. The arrangement of the filter plate at the lower end of the straw 7 avoids the impact on the normal use of the device because foreign matters in the oil storage bottle 4 enter the housing 3. By the mounting the double-torque spring 16 at the inner upper end of the housing 3, this design provides a sufficient elastic force to quickly reset the trigger 2 and make the trigger 2 to main a uniform rebound force for a long time.

Referring to FIG. 1, FIG. 2, and FIG. 3, a first channel 19 and a second channel 20 are mounted on the bottom of the piston chamber 18, and a pre-atomization chamber 12 and a pre-atomization channel 11 are on one side inside the housing 3. The pre-atomization chamber 12 is connected to the second channel 20 and the pre-atomization channel 11, and the pre-atomization channel 11 is connected to the nozzle 1. A pressure chamber 21 is mounted on the bottom inside the housing 3. A pressure valve bottom plug 23 is mounted on the bottom inside the pressure chamber 21. A pressure valve spring plug 22 is mounted on the top of the pressure valve bottom plug 23. A pressure valve piston spring 6 is mounted on the top of the pressure valve spring plug 22. A pressure valve piston body 13 is mounted on the top of the pressure valve piston spring 6. A pressure valve piston push rod 14 is mounted on the bottom of the pressure valve piston body 13, and the pressure valve piston push rod 14 is slidably arranged inside the pressure valve piston spring 6.

Specifically, the first channel 19 and the second channel 20 are mounted on the bottom of the piston chamber 18, and the pre-atomization chamber 12 and the pre-atomization channel 11 are arranged on one side inside the housing 3, so that it facilitates communication between the piston chamber 18 and the nozzle 1 and smoothly sprays out the cooking oil. The pressure valve piston spring 6 pushes the pressure valve piston body 13 to move upwards, which is beneficial to make the pre-atomization channel 11 and the pre-atomization chamber 12 always full of liquid. The pressure valve piston push rod 14 is mounted on the bottom of the pressure valve piston body 13. This design makes the pressure valve piston body 13 move up and down in the pressure chamber 21 more stably.

The working principle is as follows: During use of the device, the trigger 2 is pressed to drive the piston main body 17 to move downwards; a valve gasket of the first channel 19 is sealed, and a valve gasket of the second channel 20 is opened. Liquid in the piston chamber 18 enters the pre-atomization chamber 12 through the second channel 20. When the pre-atomization chamber 12 is filled with the liquid, the liquid may enter the pre-atomization channel 11. The pressure valve piston body 13 moves downwards. When the pre-atomization channel 11 and the pre-atomization chamber 12 are filled with the liquid, the trigger 2 is pressed again. The pressure pushes the sealing valve body 9 to move backwards, and the liquid is atomized and sprayed out from the nozzle 1. After one oil spraying activity ends, the pressure on the sealing valve body 9 is less than a load value of the sealing valve spring 15. The sealing valve spring 15 returns to its original state, and the sealing valve body 9 moves forwards to seal the nozzle 1. Meanwhile, the pressure valve piston body 13 moves upwards, so that the pre-atomization channel 11 and the pre-atomization chamber 12 are always filled with the liquid. The trigger 2 is pressed, and the piston main body 17 is released. The double-torque spring provides a sufficient elastic force to quickly reset the trigger 2. The piston main body 17 moves upwards. The valve gasket of the first channel 19 is opened, and the valve gasket of the second channel 20 is sealed. The liquid in the oil storage bottle 4 enters the piston chamber 18 through the straw 7. Meanwhile, air enters the air inlet hole 5 to maintain consistent pressure inside and outside the bottle.

It should be finally noted that the above describes only the preferred embodiments of the present disclosure and is not intended to limit the present disclosure. Although the present disclosure is described in detail with reference to the foregoing embodiments, a person skilled in the art may still make modifications to the technical solutions described in the foregoing respective embodiments or make equivalent replacements to partial technical features thereof. Any modification, equivalent replacement, improvement, and the like made within the spirit and principle of the present disclosure shall fall within the protection scope of the present disclosure.

What is claimed is:

1. A pressurized oil spray bottle structure, comprising a housing (3), wherein a piston chamber (18) is in the housing (3); a piston main body (17) is slidably arranged in the piston chamber (18); a double-torque spring (16) is on one side of an inner upper end of the housing (3); a trigger (2) is arranged on one side, away from the double-torque spring (16), in an upper end of the housing (3); a sealing valve body (9) is mounted on the top inside the housing (3); a sealing valve spring (15) is arranged in the sealing valve body (9); a nozzle (1) is on one side of the sealing valve body (9); and an oil receiving box (10) is mounted on the bottom of the nozzle (1).

2. The pressurized oil spray bottle structure according to claim 1, wherein an oil storage bottle (4) is sleeved in a lower end of the housing (3) through a thread, and an air inlet hole (5) is fixedly provided in one side inside the housing (3).

3. The pressurized oil spray bottle structure according to claim 1, wherein a straw (7) is mounted on the bottom inside the housing (3), and a foreign matter filter plate (8) is mounted on the bottom of of the straw (7).

4. The pressurized oil spray bottle structure according to claim 1, wherein a first channel (19) and a second channel (20) are mounted on the bottom of the piston chamber (18), and a pre-atomization chamber (12) and a pre-atomization channel (11) are on one side inside the housing (3).

5. The pressurized oil spray bottle structure according to claim 4, wherein the pre-atomization chamber (12) is connected to the second channel (20) and the pre-atomization channel (11), and the pre-atomization channel (11) is connected to the nozzle (1).

6. The pressurized oil spray bottle structure according to claim 1, wherein a pressure chamber (21) is mounted on the bottom inside the housing (3); a pressure valve bottom plug (23) is mounted on the bottom inside the pressure chamber (21); and a pressure valve spring plug (22) is mounted on the top of the pressure valve bottom plug (23).

7. The pressurized oil spray bottle structure according to claim 6, wherein a pressure valve piston spring (6) is mounted on the top of the pressure valve spring plug (22); and a pressure valve piston body (13) is mounted on the top of the pressure valve piston spring (6).

8. The pressurized oil spray bottle structure according to claim 7, wherein a pressure valve piston push rod (14) is mounted on the bottom of the pressure valve piston body (13), and the pressure valve piston push rod (14) is slidably arranged inside the pressure valve piston spring (6).
